(19) United States
(12) Patent Application Publication
(10) Pub. No.: US 2006/0213747 A1
(43) Pub. Date: Sep. 28, 2006

(54) Axially adjusting device with disk spring multiplication

(76) Inventor: Klaus Matzschker, Neunkirchen (DE)

Correspondence Address: ARTZ & ARTZ, P.C., 28333 TELEGRAPH RD., SUITE 250, SOUTHFIELD, MI, 48034, US

(21) Appl. No.: 10/562,350

(22) PCT Filed: Jul. 23, 2004
(86) PCT No.: PCT/EP04/08222

§ 371 Date: May 2, 2006

(30) Foreign Application Priority Data
Jul. 29, 2003 (DE) 103344683

(51) Int. Cl. F16D 27/00

(52) U.S. Cl. 192/84.6; 192/84.7

(57) ABSTRACT

A coupling assembly (11) having an axial setting device (21) in the form of a ball ramp assembly with an axially supported supporting disc (23) and an axially displaceable pressure disc (24) with ball grooves (25, 26) and balls (27). The supporting disc (23) and the pressure disc (24) are rotatable relative to one another by a motor, wherein the pressure disc (24) acts on a first pressure plate (42). The coupling assembly (11) is loaded by a second pressure plate (36), and a disc spring (43) is arranged between the first pressure plate (42) and the second pressure plate (46). The disc spring (43) which, at its outer circumference, is axially secured in the coupling carrier (12), acts on the second pressure plate (46) by an intermediate diameter and, at its inner edge, rests against the first pressure plate.

### TECHNICAL FIELD

The invention relates to a coupling assembly having an axial setting device in the form of a ball ramp assembly with an axially supported supporting disc and an axially displaceable pressure disc which, in their end faces facing one another, are provided with ball grooves whose depth is circumferentially variable in opposite directions, wherein balls via which the supporting disc and the pressure disc axially support one another run in pairs of ball grooves and wherein the supporting disc and the pressure disc are rotatable relative to one another by being driven by a motor.

### BACKGROUND

Coupling assemblies of this type are widely used in the drivelines of motor vehicles in the form of locking couplings for differential drives or in the form of so-called hang-on couplings for optionally driving an additional driving axle. However, their field of application is not limited to said ranges of use. As a rule, the electromotive drive of at least one of the discs rotatable relative to one another, i.e. the supporting disc and the pressure disc, is effected via a spur gear reduction stage, with a transmission ratio of 1:50 being typical. This results in high axial loads on the axial bearings used for the support of, or pressure transmission to, the two discs. There are generated extremely high pressure loads on the few supporting balls in the pairs of ball grooves.

### SUMMARY OF THE INVENTION

It is an object of the present invention to reduce the above-described high loads on the ball ramp assembly without having to accept a reduction in the axial setting forces at the coupling assembly. The objective is achieved in that the pressure disc of the ball ramp assembly acts on the first pressure plate and that the coupling assembly is loaded by a second pressure plate, wherein a disc spring is arranged between the first pressure plate and the second pressure plate, wherein the apex of the disc angle of the disc spring points towards the first pressure plate and which disc spring, at its outer circumference, is axially secured in the coupling carrier, acts on the second pressure plate by means of an intermediate diameter and, at its inner edge, rests against the first pressure plate.

### BRIEF DESCRIPTION OF THE DRAWINGS

FIG. 1 shows a partial cross-sectional view of an embodiment of the invention.

FIG. 1 shows half a longitudinal section through an inventive coupling assembly. The coupling assembly 11 comprises a coupling carrier 12 and a coupling hub 13 between which there is positioned a plate package 14. Outer coupling plates are connected to the coupling carrier 12 and inner coupling plates are connected to the coupling hub 13. The coupling assembly is axially loaded by an axial setting device 21 which comprises a supporting disc 23 supported in a housing 22, as well as a pressure disc 24 which is axially displaceable. The discs 23, 24 comprise circumferentially extending ball groves 25, 26 whose depth changes circumferentially in opposite directions. Between the pairs of ball grooves 25, 26 there are arranged balls 27 one of which can be seen in the FIGURE. Via a needle bearing 28, the pressure disc 24 is rotatably supported on the coupling hub 13. The supporting disc 23 is circumferentially held in the housing 22. The pressure disc 24 is rotatingly drivable via a spur gear drive 31 which comprises an intermediate shaft 32 with a double pinion 33, 34 and is drivable by a driving pinion 35. The pinion 35 is positioned on the output shaft 36 of an electric motor 37. The bearing for the intermediate shaft is not shown. With the rotating drive being provided by the electric motor, the pressure disc 24 is rotated via the spur gear drive and axially pushes itself away from the supporting disc 23. The axial setting device 21 acts via an axial bearing 41 directly on a first pressure plate 42 which is contacted by the inner circumference of a disc spring 43. The apex of the disc angle of the disc spring 43 points towards the first pressure plate 42. The outer circumference of the disc spring 43 is supported via two securing rings 44, 45 in the coupling carrier 12. In front of the plate package 14 there is positioned a second pressure plate 46 which, on an intermediate diameter D3, near the outer circumference, comprises an annular collar 47 which is contacted by the disc spring 43. The intermediate diameter D3 is thus from the rotational axis of the carrier 12 to the annular collar 47 which is near the outer circumference of the disc spring 43. When the first pressure spring 42 is axially displaced, the disc spring 43 secured in the coupling carrier 12 acts with a high lever effect on the annular collar 47 at the second pressure plate 46, so that with longer setting paths and lower forces at the first pressure plate 42, shorter setting paths and higher pressure forces occur at the second pressure plate 46. The ball ramp assembly 21 is thus freed from axial forces, i.e. more particularly, the forces at the axial bearing 41 and in the ball grooves 25, 26 are reduced considerably. The radial distance D1 between the outer edge of the disc spring 43 and the annular collar 47 is much smaller than the radial distance D2 between the annular collar 47 and the inner edge of the disc spring 43.

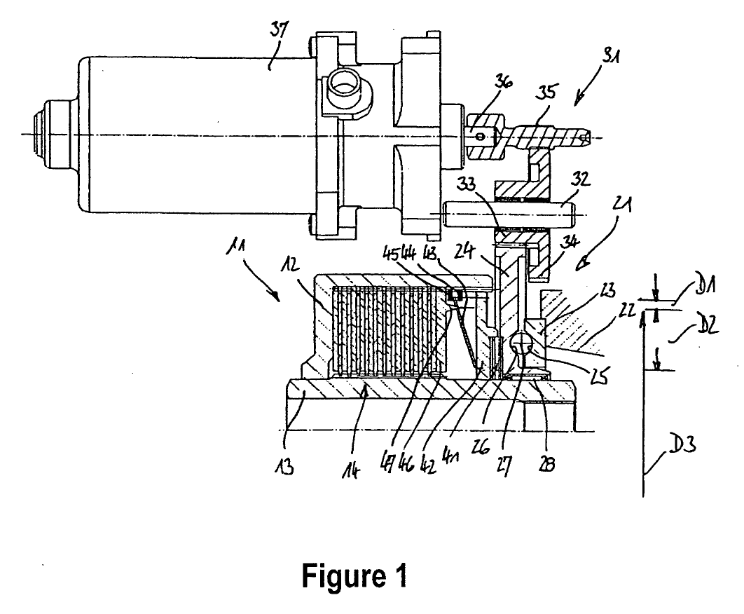

In the present assembly in accordance with an embodiment of the invention a transmission reduction between the pressure disc 24 and the coupling assembly is achieved via a disc spring 43 which generates a lever effect. With reduced axial forces at the ball ramp assembly 21 it is nevertheless possible to apply high forces to the coupling assembly. In one embodiment, an axial bearing 41 is arranged between the first pressure plate 42 and the pressure disc 24. The load on said axial bearing 41 is also reduced.

According to a further embodiment, the distance D1 between the outer edge of the disc spring 43 and the intermediate diameter D3 is smaller than the distance D2 between the intermediate diameter D3 and the inner edge of the disc spring 43, more particularly, it is smaller by a multiple thereof. The second pressure plate 46, on the intermediate diameter D3, can also comprise a formed on annular collar 47 which is in contact with the disc spring 43.

Furthermore, the disc spring 43, by its inner edge, freely rests against a radial face of the first pressure plate 42, with the disc spring 43, by its outer edge, being axially fixed between two securing rings 44,45 secured in a coupling carrier.

The coupling assembly used can be a multi-plate coupling with a coupling carrier 12 and a coupling hub 13, with the plates alternately being connected to the coupling carrier and to the coupling hub and with the plate package 14 being supported on the coupling carrier 12.

What is claimed is:

1. A coupling assembly comprising an axial setting device in the form of a ball ramp assembly with an axially supported supporting disc and an axially displaceable pressure disc which, in their end faces facing one another, are provided with ball grooves whose depth is circumferentially variable in opposite directions, wherein balls via which the supporting disc and the pressure disc axially support one another run in pairs of ball grooves and wherein the supporting disc and the pressure disc are rotatable relative to one another by being driven by a motor, wherein the pressure disc acts on the first pressure plate and the coupling assembly is loaded by a second pressure plate, wherein a disc spring is arranged between the first pressure plate and the second pressure plate, wherein the apex of the disc angle of the disc spring points towards the first pressure plate and which disc spring, at its outer circumference, is axially secured in a coupling carrier, and acts on the second pressure plate by an intermediate diameter (D3) and, at its inner edge, rests against the first pressure plate.

2.-7. (canceled)

8. A coupling assembly according to claim 1, wherein a distance (D1) between an outer edge of the disc spring and the intermediate diameter (D3) is smaller than a distance (D2) between the intermediate diameter and an inner edge of the disc spring (43).

9. A coupling assembly according to claim 8, wherein (D1) is less than (D2) by a multiple thereof.

10. A coupling assembly according to claim 1, wherein the second pressure plate, on the intermediate diameter (D3), comprises a formed on annular collar which is in contact with the disc spring.

11. A coupling assembly according to claim 8, wherein the second pressure plate, on the intermediate diameter (D3), comprises a formed on annular collar which is in contact with the disc spring.

12. A coupling assembly according to claim 1, wherein the disc spring, by its inner edge, freely rests against a radial face of the first pressure plate.

13. A coupling assembly according to claim 8, wherein the disc spring, by its inner edge, freely rests against a radial face of the first pressure plate.

14. A coupling assembly according to claim 1, wherein the disc spring, by its outer edge, is axially fixed between two securing rings secured in the coupling carrier.

15. A coupling assembly according to claim 8, wherein the disc spring, by its outer edge, is axially fixed between two securing rings secured in the coupling carrier.

16. A coupling assembly according to claim 12, wherein the disc spring, by its outer edge, is axially fixed between two securing rings secured in the coupling carrier.

17. A coupling assembly according to claim 1 comprising a multi-plate coupling with said coupling carrier and a coupling hub, whose coupling plates are alternately connected to the coupling carrier and the coupling hub, wherein the plate package is axially supported against the coupling carrier.

18. A coupling assembly according to claim 8 comprising a multi-plate coupling with said coupling carrier and a coupling hub, whose coupling plates are alternately connected to the coupling carrier and the coupling hub, wherein the plate package is axially supported against the coupling carrier.

19. A coupling assembly according to claim 12 comprising a multi-plate coupling with said coupling carrier and a coupling hub, whose coupling plates are alternately connected to the coupling carrier and the coupling hub, wherein the plate package is axially supported against the coupling carrier.

20. A coupling assembly according to claim 14 comprising a multi-plate coupling with said coupling carrier and a coupling hub, whose coupling plates are alternately connected to the coupling carrier and the coupling hub, wherein the plate package is axially supported against the coupling carrier.

21. A coupling assembly according to claim 1 comprising an axial bearing arranged between the first pressure plate and the pressure disc of the ball ramp assembly.

22. A coupling assembly according to claim 8 comprising an axial bearing arranged between the first pressure plate and the pressure disc of the ball ramp assembly.

23. A coupling assembly according to claim 12 comprising an axial bearing arranged between the first pressure plate and the pressure disc of the ball ramp assembly.

24. A coupling assembly according to claim 14 comprising an axial bearing arranged between the first pressure plate and the pressure disc of the ball ramp assembly.

25. A coupling assembly according to claim 17 comprising an axial bearing arranged between the first pressure plate and the pressure disc of the ball ramp assembly.
